(19) United States
(12) Patent Application Publication
(10) Pub. No.: US 2005/0126927 A1
(43) Pub. Date: Jun. 16, 2005

(54) Water supply system for an aircraft

(76) Inventors: Christiane Lindauer, Hamburg (DE); Torsten Gienke, Rellingen (DE)

Correspondence Address: FASSE PATENT ATTORNEYS, P.A., P.O. BOX 726, HAMPDEN, ME, 04444-0726, US

(21) Appl. No.: 10/971,823

(22) Filed: Oct. 21, 2004

(30) Foreign Application Priority Data
Oct. 22, 2003 (DE) 103 49 158.9

(51) Int. Cl. C02F 1/467

(52) U.S. Cl. 205/743

(57) ABSTRACT

A water supply system, particularly for an aircraft such as a passenger aircraft, includes a disinfecting unit with an electrolysis cell connected in series with a water storage tank including a water distribution pipe system and a circulating pump. A bypass pipe with a valve permits connecting the electrolysis cell to the distribution system or bypassing the electrolysis cell. The electrolysis cell disinfects the water by anodic oxidation. A salt solution container may be connected to the electrolysis cell to enhance the anodic oxidation. The pump circulates the disinfected water through the tank and/or through the entire system, whereby the water supply is disinfected and the disinfected water in turn disinfects the entire system.

### PRIORITY CLAIM

This application is based on and claims the priority under 35 U.S.C. §119 of German Patent Application 103 49 158.9, filed on Oct. 22, 2003, the entire disclosure of which is incorporated herein by reference.

### FIELD OF THE INVENTION

The invention relates to a water supply system particularly suitable for use in a passenger aircraft for supplying disinfected water for use by the passengers and crew.

### BACKGROUND INFORMATION

Water supply systems for aircraft comprise at least one water storage tank and a water distribution pipe system with a water circulating pump between a water dispenser, such as a faucet or a toilet, and a water storage tank. If a water disinfecting unit is installed on special aircraft types, the water disinfecting unit is usually connected to the distribution pipe system.

After each flight it is necessary to entirely drain the water supply system of a passenger aircraft in order to prevent germination in the system. Such complete draining is particularly important where prolonged aircraft ground times must be taken into account, particularly in warm climates. Draining the aircraft's water system is also required when the aircraft may be exposed to subfreezing temperatures on the ground in order to avoid frost damages.

If germs remain in the system after an incomplete draining, thereby leaving water in the system, the remaining water will contaminate the fresh water. The fresh, refilled water may also be contaminated by so-called biofilms which cannot be removed even by a complete draining. Biofilms are microbiological contaminations which form as thin layers on the inner surfaces of pipes, tanks and the like. Such thin layers or films protect bacteria and form a living base for germs and other microorganisms which later are emitted into the water flow of the system. Moreover, germs may be contained in any refill water due to, for example lack of due care during refilling or due to poor water conditions of the water available for refill or due to unsanitary conditions at the source for refilling.

The above mentioned water disinfecting aside, there are currently generally no systems used in passenger aircraft for dealing with the above problems, more specifically for improving the water quality in commercial aircraft. Rather, merely filters are installed for an individual faucet. Such filters prevent the passage of bacteria. Additionally to the filters or alternatively thereto the fresh water supply is chlorinated with small chlorine concentrations.

Although filters can prevent bacteria from entering the water being consumed, such filters cannot eliminate bacteria present in the system. Thus, bacteria remain in the system, unaffected by any filter. Moreover such filters cannot prevent germs from coming externally in contact with the system, for example germs living on a water faucet. Such germs can contaminate the outlet portion of the system, downstream of the individual faucet filter. Further, chlorination has its own problems, particularly decomposition of the chlorine over time so that its effectiveness as a germ killer declines. Thus, chlorination must be repeated at least for each refilling.

U.S. Pat. No. 6,463,956 B2 discloses a normally pressureless water recirculation system comprising a component for killing organic contaminations and/or filters for the removal of organic materials. Such systems improve the water quality or at least prevent a reduction of the water quality. However, such systems are not provided for use in aircraft. A pump is required for sustaining circulation during decontamination under pressure and for releasing heat sufficient to kill germs. It is a disadvantage of the known system, that the release of heat below a germ killing temperature level is beneficial for germs to grow. As a result means for degermination or disinfection are required additionally to the pumping equipment.

European Patent Publication EP 0,653,520 A2 describes a water supply system of the type mentioned above which is used in restaurant cars of passenger trains. The known system for trains includes a water storage tank, a water circulating pipe system, an ultraviolet degermination unit and a pressurized pipeline to a faucet or the like. A rotary or centrifugal pump provides the increased pressure in the pressurized pipeline to sustain circulation in the system. However, it is a drawback of the known system that the degermination by an ultraviolet treatment does not have any durable effect on the water distribution system itself. As a result, the water quality made available for human consumption is not improved for prolonged periods of time.

### OBJECTS OF THE INVENTION

In view of the above it is an aim of the invention to achieve the following objects singly or in combination:
to provide a water treatment system capable of improving the quality particularly of the drinking water in a passenger aircraft so that the quality remains constantly good and at a hygienically acceptable level;
to electrolyze the drinking water in an aircraft for an anodic water oxidation prior to consumption;
to provide an electrolyzing bypass so that the electrolyzation may be performed when needed, preferably in response to a signal generated by a water analyzer and/or in response to a standardized water quality representing control signal; and
to disinfect the water supply of an aircraft in such a way that the disinfected water will also disinfect all components of the water distribution system through which the disinfected water circulates.

The invention further aims to avoid or overcome the disadvantages of the prior art, and to achieve additional advantages, as apparent from the present specification. The attainment of these objects is, however, not a required limitation of the claimed invention.

### SUMMARY OF THE INVENTION

The above objects have been achieved according to the invention by the combination of the following features. A passenger aircraft is equipped with a water supply system including at least one water supply source such as a storage tank and at least one water consumption outlet, a water distribution pipe system interconnecting said at least one water consumption outlet to said at least one water supply source, a circulation pump operatively connected to said water distribution pipe system and an electrolysis cell operatively connected to said water distribution system for disinfecting water in said supply system by anodic oxidation.

According to the invention there is further provided a method for disinfecting water in a water supply system for a passenger aircraft including at least one water storage tank, said method comprising the following steps:
a) circulating said water in said water supply system to provide a circulating water stream;
b) passing said circulating water stream from said water storage tank through an electrolysis cell for subjecting said water to an anodic oxidation to produce disinfected water; and
c) feeding said disinfected water from said electrolysis cell back into said circulating water stream for disinfecting said water supply system with said disinfected water.

According to the invention the disinfection is achieved by an electrolysis cell in which the water is subjected to anodic oxidation. Anodic oxidation as such is known from World Patent Publication WO 02/26636 A1.

The anodic oxidation may be performed in the water supply of a passenger aircraft either with or without the addition of salts to the water being electrolyzed. Such an anodic oxidation directly kills or deactivates all microorganisms in the electrolysis cell operatively connected to a water supply storage tank by a pump for sustaining the circulation. The electrolysis cell is also indirectly effective in the entire water supply system through the disinfected water stream flowing from the electrolysis cell through the system and back to the cell for repeated anodic oxidation.

Compared to conventional filtering the electrolyzing as taught herein has the advantage that the water in the entire water distribution system of the aircraft is maintained disinfected and hence fresh at all times. A further important advantage compared to the above described prior art, particularly compared to simply adding disinfecting agents to the water in an aircraft, is seen in that the disinfection by electrolysis is effective in the drinking water and in the entire piping system by avoiding the formation of the above mentioned biofilms on the inner surface of any distribution system component that comes into contact with the water disinfected by the electrolysis cell. Thus, the electrolysis cell has a direct beneficial effect on the water itself and a remote effect on the entire distribution system. This remote effect even attacks and kills stubborn germinations and removes old biofilms. These effects of the anodic oxidation of the water in the system are particularly efficient if the water is circulated by a pump so that water passes repeatedly through the electrolysis cell.

In a preferred embodiment a water analyzer constantly monitors the water quality particularly for the presence of sufficient disinfectants. The analyzer produces a control signal in response to an insufficient disinfection. This control signal operates for example at least one controllable flow control valve which switches the electrolysis cell into the system when the valve is closed in a bypass parallel to the cell or which causes the water flow to bypass the electrolysis cell when the valve is open. When two controllable valves are used, one of which is connected in parallel to the cell while the other valve is connected in series with the cell, the arrangement is such that one valve is closed while the other valve is open and vice versa.

It has been found that even germ accumulations that have been removed out of old biofilms by the circulating flow or stream of disinfected water are effectively killed in the electrolysis cell. Thus, it is no longer necessary to add disinfectant agents, such as chlorine, to the water supply in the aircraft. This fact entails the advantage that there is no need for storing such disinfectants in the form of chemicals that may be a health hazard if stored in concentrated form.

### BRIEF DESCRIPTION OF THE DRAWINGS

In order that the invention may be clearly understood, it will now be described in connection with example embodiments thereof, with reference to the accompanying drawings, wherein:

FIG. 1 shows a basic water flow diagram of a water distribution piping system in a jumbo passenger aircraft equipped with an electrolysis cell for disinfecting the water supply according to the invention;

FIG. 2 shows further details of the connections of the electrolysis cell to the system for providing a water disinfection; and

FIG. 3 symbolically illustrates the anodic oxidation.

### DETAILED DESCRIPTION OF A PREFERRED EXAMPLE EMBODIMENT AND OF THE BEST MODE OF THE INVENTION

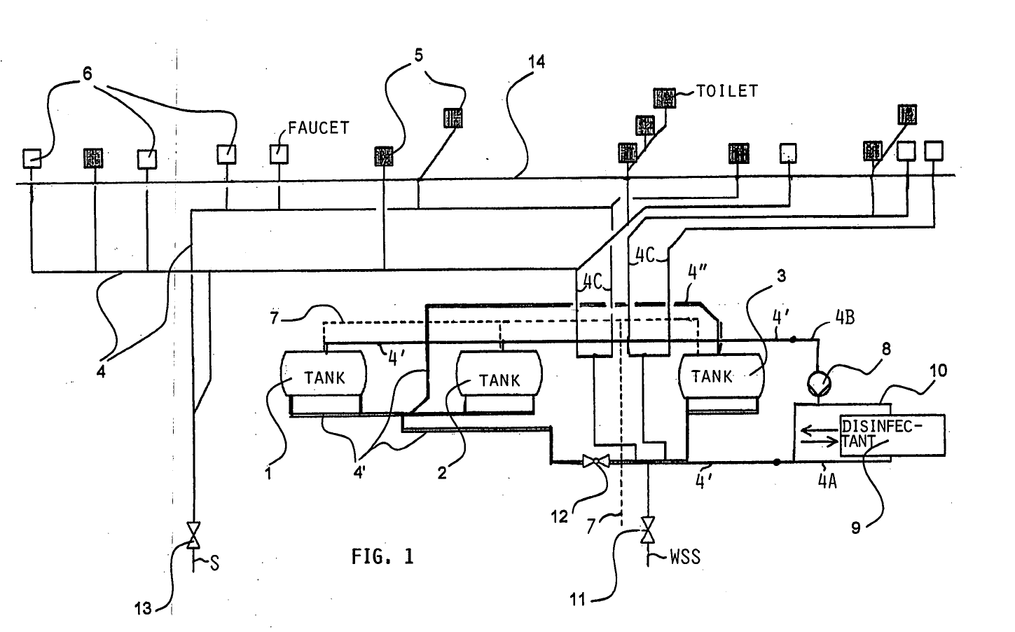

The water flow diagram of FIG. 1 shows a water supply piping or plumbing system for a passenger aircraft, particularly of the jumbo type. The plumbing system comprises preferably a plurality of water storage tanks 1, 2, 3 connected by fresh water supply pipes 4 to water use components such as toilets 5, faucets 6, and the like. Additionally, all tanks 1, 2, 3 are connected in parallel to each other by water circulating pipelines 4′. A venting and overflow line 7 connects all tanks to the atmosphere outside an aircraft body not shown. A valve 11 permits filling the tanks or any tank 1, 2, 3 simultaneously from a water supply source WSS, not shown in detail, when the valve 11 is opened. Valve 11 also permits draining the system to the outside. A valve 12 is normally open when all three tanks are to be filled simultaneously. However, if the valve 12 is closed, tank 3 will be filled first. A pipeline 4″ then permits filling tanks 1 and 2 when tank 3 reaches a filling level below its overflow level. A valve 13 is used to drain the system forward part. It also permits supplying water to the use components 5, 6 from a source S for example for cleaning on the ground by circulating the water. Pipelines 4C are connected to the circulating pipelines 4′ for passing or circulating disinfected water to the use components 5, 6.

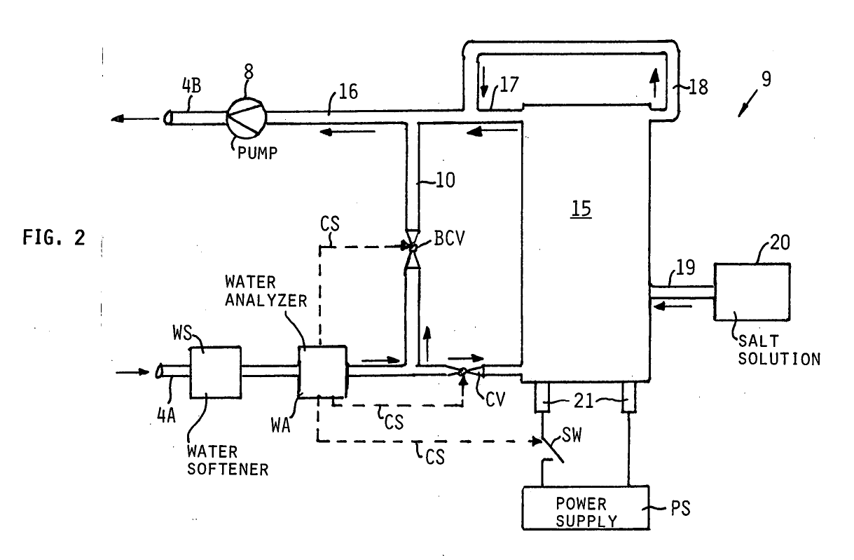

According to the invention the parallel connection of the tanks 1, 2, 3 with its pipelines 4′ is connected by pipelines 4A, 4B to a disinfecting unit 9 connected in series with a circulating pump 8. A bypass pipe or conduit 10 is connected in series with the pump 8 and in parallel to the disinfecting unit 9. As shown in FIG. 2, a controllable bypass control valve BCV is connected in the bypass conduit 10. Preferably, a further controllable valve CV is connected in series with the disinfecting unit 9 between the bypass conduit 10 and an inlet of the disinfecting unit 9. The flow direction of the circulating pump 8 is from the outlet of the disinfecting unit 9 to the tanks 1, 2, 3.

FIG. 1 also shows that all plumbing components described above, except the faucets and toilets, but including the elements of the disinfecting unit 9 and the circulating pump 8 are installed below the passenger cabin floor 14. The arrows next to the disinfecting unit 9 indicate the water flow into and out of the disinfecting unit 9.

FIG. 2 shows details of the disinfecting unit 9 comprising an electrolysis cell 15 having a water inlet connected through the control valve CV to the pipeline 4A and to the bypass conduit 10. The electrolysis cell 15 has a first outlet 17 for discharging oxidation agents and a second outlet 18 for discharging reduction agents. The two outlets 17 and 18 are joined by a pipeline 16 connected to the bypass conduit 10 and to the circulating pump 8, which in turn is connected to the pipeline 4B connecting to the pipelines 4′ of the parallel connection of tanks 1, 2, 3. The electrolysis cell 15 further has two electric terminals 21. One terminal is an anode, the other terminal is a cathode. Both terminals 21 are connected to a power supply PS which is preferably the aircraft's electrical power supply system. The supply of power to the cell 15 is controllable, preferably automatically, by a switch SW.

FIG. 2 further shows a conduit 19 connecting a salt solution container 20 to the hydrolysis cell 15. Preferably the container 20 holds a solution of sodium chloride (NaCl) for enhancing the hydrolysis. A water softener WS is preferably connected to or in the pipeline 4′ or 4A. With suitable valves, not shown, the water softener may be used or bypassed depending on the hardness of an available water supply for refilling. Further, a water analyzer WA is preferably connected to the system for generating a control signal CS for controlling the above mentioned controllable valves BCV and CV and/or the switch SW in the power supply line for the electrolysis cell 15.

In operation when the electrolysis cell 15 is used the valve CV is open and the valve BCV is closed, thus causing water from the tanks 1, 2, 3 to circulate through the electrolysis cell 15 since the bypass pipe 10 is closed by the valve BCV. The cell 15 kills and/or deactivates all microorganisms by anodic oxidation not only in the water passing through the cell 15 but also in the entire water supply system as the electrolyzed water stream is circulated through the system by the pump 8.

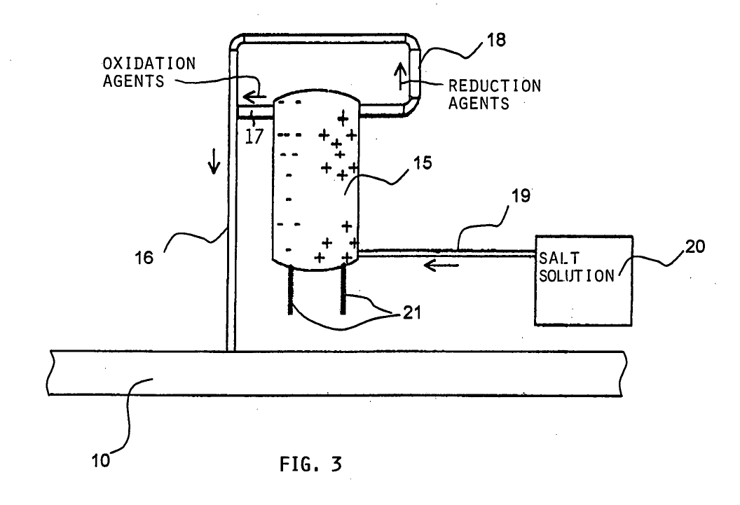

The germs are killed in the cell 15 primarily by an anodic oxidation, whereby electrons are removed directly in the anode-water interface. The oxidation also extends into the boundary area between the water and the anode as indicated by “+” signs in the cell 15 as shown in FIG. 3. More specifically, atomic oxygen, atomic chlorine, and hydroxide radicals are directly generated along the anode or the interface between the water and the anode. An indirect oxidation takes place in the boundary area, also referred to as “anolytspace”. The disinfection is based on the formation of molecular oxygen and molecular chlorine and by a change in the carbon dioxide equilibrium. The molecular chlorine is hydrolyzed to form hypochloric acid, whereby the disinfection is further improved.

The indirect disinfection of the entire water supply system according to the invention, namely outside the cell 15, is accomplished by a number of substances acting as disinfectants which are produced in the so-called anolytspace. These disinfectants are flowing with the electrolyzed water driven by the pump 8 through the entire system thereby rinsing the system. This disinfection of the entire system is sustained by the formation of molecular oxygen and molecular chlorine which is hydrolyzed to form hypochloric acid and by the change of the carbon dioxide equilibrium, as mentioned above.

When a salt solution is added to the electrolysis process from the container 20, further reaction products result. These reaction produces support the disinfection process and thus act as additional disinfectants. The products resulting from the electrolysis at the anode of the cell 15 are called anodic products having negative ions (−) and a low pH-value: namely: hypochloric acid (HOCl); chloric dioxide (ClO₂); ozone (O₃); chlorine (Cl₂); oxygen (O₂) and hydroxide-ions (OH). The products resulting at the cathode have positive ions (+) and a high pH value, namely sodium hypochlorite (NaOCl); sodium lye or sodium caustic solution (NaOH) and gaseous hydrogen (H₂).

The anodic oxidation performed by the electrolysis cell 15 constantly introduces disinfectants into the water flow or stream kept circulating by the pump 8. The continuous water circulation by the pump 8 makes certain that the content of reaction products or agents is constant to assure the required disinfection by electrolysis, specifically anodic oxidation. To assure the constancy of the disinfection one or more water content analyzers WA are connected to the distribution system at least at one point preferably at various points in the system. The water analyzer provides the control signals CS for operating the valves BCV and CV in response to the water content of disinfectants. The control signal CS may also be used to control the switch SW for switching the power supply PS to the cell 15 on or off.

In order to switch the electrolysis cell 15 temporarily out of the water circulating system the valve BCV is opened and the valve BC is closed, for example for performing maintenance work. For this purpose these valves are also manually controllable.

Rather than measuring or analyzing the content of disinfectants in the disinfected water, for the automatic control of the controllable valves BCV and CV, it is possible to automatically control the operation of the electrolyzing cell 15 in response to a standardized parameter value representing an acceptable level of disinfection. This control in response to a standardized parameter may be performed instead of or in addition to the control by the water analyzer WA.

It is a further feature of the invention to flow circulating electrolyzed water not only through the pipelines 4′ that are connected to the electrolyzing conduits 4A and 4B, but also through the conduits 4 for disinfecting the entire distribution system.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A passenger aircraft comprising a water supply system including at least one water storage tank and at least one water consumption outlet, a water distribution pipe system interconnecting said at least one water consumption outlet to said at least one water storage tank, a circulation pump (8) operatively connected to said water distribution pipe system and an electrolysis cell (15) operatively connected to said water distribution system for disinfecting water by anodic oxidation.

2. The water supply system of claim 1, further comprising a salt solution container (20) operatively connected to said electrolysis cell (15).

3. The water supply system of claim 2, wherein said salt solution container (20) holds a sodium chloride (NaCl) solution.

4. The water supply system of claim 1, further comprising a bypass pipe (10) and at least one bypass control valve (BCV) in said bypass line connected in parallel to said electrolysis cell (15) and to said water distribution pipe system for selectively connecting said water supply system to said water distribution pipe system and to said electrolysis cell, whereby water from said water storage tank passes through said electrolysis cell (15) when said bypass valve is closed and through said bypass pipe (10) when said bypass valve (BCV) is open.

5. The water supply system of claim 1, wherein said circulation pump (8) is connected to an output of said electrolysis cell (15) and to said water distribution pipe system for feeding electrolyzed water throughout said water supply system.

6. The water supply system of claim 1, wherein said electrolysis cell (15) is operatively connected to said at least one water storage tank for exclusively supplying electrolyzed and disinfected water into said at least one water storage tank.

7. The water supply system of claim 6, wherein said water circulation pump (8) is connected between said electrolysis cell (15) and said at least one water storage tank.

8. The water supply system of claim 1, further comprising at least one water analyzer (WA) connected to said water distribution pipe system for analyzing water regarding a disinfectant content in said disinfected water for producing a control signal.

9. The water supply system of claim 8, further comprising a bypass control value (BCV) having a control input operatively connected to said water analyzer (WA) for transmitting said control signal for opening or closing said bypass control valve in a pipeline connected in parallel to said electrolysis cell (15), whereby said electrolysis cell is connectable and disconnectable from said water distribution pipe system in response to said control signal from said water analyzer.

10. The water supply system of claim 1, further comprising a water softener (WS) operatively connected to said water distribution pipe system.

11. The water supply system of claim 10, wherein said water softener (WS) is connected to said water distribution pipe system upstream of said electrolysis cell (15) as viewed in a water flow direction through the system.

12. A method of disinfecting water in a water supply system for a passenger aircraft including at least one water storage tank, said method comprising the following steps:
a) circulating said water in said water supply system to provide a circulating water stream,
b) passing said circulating water stream from said water storage tank through an electrolysis cell (15) for subjecting said water to an anodic oxidation to produce disinfected water, and
C) feeding said disinfected water from said electrolysis cell back into said circulating water stream for additionally disinfecting said water supply system.

13. The method of claim 12, further comprising returning said disinfected water into said at least one water storage tank for disinfecting said water storage tank.

14. The method of claim 12, further comprising adding a salt solution to said circulating water stream at a location in said water supply system for enhancing said anodic oxidation.

15. The method of claim 14, wherein said salt solution is sodium chloride.

16. The method of claim 12, further comprising passing said circulating water stream trough a water softener.

17. The method of claim 12, further comprising analyzing said circulating water stream to produce a control signal and controlling an operation of said electrolyzing cell by said control signal.

18. The method of claim 12, further comprising generating a control signal for the operation of said electrolyzing cell, said control signal depending on a standardized water quality value.

19. The method of claim 12, further comprising repeatedly recirculating disinfected water through said electrolysis cell (15).
